(19) United States
(12) Patent Application Publication
(10) Pub. No.: US 2017/0129318 A1
(43) Pub. Date: May 11, 2017

(54) SIDE DOOR FOR VEHICLE

(71) Applicant: Toyota Jidosha Kabushiki Kaisha, Toyota-shi Aichi-ken (JP)

(72) Inventors: Takuji Uemura, Nisshin-shi Aichi-ken (JP); Yoshinobu Yamada, Kiyosu-shi Aichi-ken (JP); Tomohiro Dosaki, Kiyosu-shi Aichi-ken (JP)

(21) Appl. No.: 15/337,775

(22) Filed: Oct. 28, 2016

(30) Foreign Application Priority Data
Nov. 5, 2015 (JP) 2015-217750

(51) Int. Cl. B60J 10/76; B60J 5/04

(52) U.S. Cl. CPC B60J 10/76; B60J 5/0402

(57) ABSTRACT

A side door for a vehicle, includes: a side door main body; a door glass; a raising-and-lowering guide rail; a slider; and a weatherstrip provided at the side door main body, the weatherstrip including: an attachment portion that extends along an aperture edge portion at the one vehicle front-rear direction side of a window aperture and is attached to the aperture edge portion, a lip portion that protrudes from the attachment portion and is pressed against a glass end portion of the door glass when the door glass is disposed at a closed position, and an outer face cover portion that is provided extending across the attachment portion and a guide portion and that covers an outer face of the guide portion at a vehicle width direction outer side of the guide portion.

### CROSS-REFERENCE TO RELATED APPLICATION

This application is based on and claims priority under 35 USC 119 from Japanese Patent Application No. 2015-217750 filed on Nov. 5, 2015, the disclosure of which is incorporated by reference herein.

### BACKGROUND

Technical Field

Preferred embodiments relate to a side door for a vehicle.

Related Art

A vehicle side door (for example, see Japanese Patent Application Laid-Open (JP-A) Nos. 2005-255113 and 2006-056472) is provided with: a side door main body including a window aperture at an upper portion thereof; a door glass that opens and closes the window aperture by being raised and lowered relative to the side door main body; a slider that protrudes toward the vehicle rear from a rear end portion of the door glass; and a weatherstrip that closes off a gap between a rear edge portion of the window aperture and the slider.

In a vehicle front side door, disposing a guide portion that guides raising and lowering of the door glass at the vehicle width direction inner side relative to the rear end portion of the door glass has been considered. In this structure, a gap between the rear end portion of the door glass and the rear edge portion of the window aperture is closed off by, for example, a weatherstrip provided along the rear edge portion of the window aperture.

However, if a guide portion is disposed at the vehicle width direction inner side relative to the rear end portion of a door glass, then when the door glass is lowered along the guide portion to open the window aperture, the guide portion is exposed through the window aperture, which may adversely affect the appearance of the vehicle side door.

As a countermeasure, providing an additional cover that covers the guide portion from the vehicle width direction outer side has been considered. However, with this structure there is concern about an increase in the number of components.

### SUMMARY

Exemplary embodiments provide a side door for a vehicle that may both reduce a number of components and make the appearance when a window aperture is open excellent.

A side door for a vehicle according to a first aspect includes: a side door main body including a window aperture at an upper portion of the side door main body; a door glass provided at the side door main body, the door glass being raised and lowered between a closed position, at which the door glass closes the window aperture, and an open position, at which the door glass is disposed at a vehicle lower side relative to the closed position and opens the window aperture; a raising-and-lowering guide rail provided at the side door main body, the raising-and-lowering guide rail including a guide portion that is disposed at a vehicle width direction inner side relative to a glass end portion at one vehicle front-rear direction side of the door glass when the door glass is disposed at the closed position, and the guide portion extending in the vehicle vertical direction along the glass end portion; a slider including a slide groove portion that is open at the one vehicle front-rear direction side, the guide portion being inserted into the interior of the slide groove portion, the slider being fixed to an inner face at the vehicle width direction inner side of the glass end portion, and the slider being raised and lowered along the guide portion; and a weatherstrip provided at the side door main body, the weatherstrip including: an attachment portion that extends along an aperture edge portion at the one vehicle front-rear direction side of the window aperture and is attached to the aperture edge portion, a lip portion that protrudes from the attachment portion and is pressed against the glass end portion of the door glass when the door glass is disposed at the closed position, and an outer face cover portion that is provided extending across the attachment portion and the guide portion and that covers an outer face of the guide portion at a vehicle width direction outer side of the guide portion.

According to the side door for a vehicle according to the first aspect, the side door main body includes the window aperture at the upper portion. The door glass is provided at the side door main body. The door glass is raised and lowered between the closed position, at which the door glass closes off the window aperture, and the open position, at which the door glass is disposed at the vehicle lower side relative to the closed position and opens up the window aperture. The raising-and-lowering guide rail that includes the guide portion is also provided at the side door main body. The guide portion is disposed at the vehicle width direction inner side relative to the glass end portion at the vehicle front-rear direction one side of the door glass when the door glass is disposed at the closed position. The guide portion extends in the vehicle vertical direction along the glass end portion.

The slider including the slide groove portion is fixed to the inner face at the vehicle width direction inner side of the glass end portion of the door glass. The slide groove portion that is open at the one vehicle front-rear direction side, and the guide portion is inserted into the interior of the slide groove portion. The slider is raised and lowered along the guide portion. Thus, raising and lowering of the door glass between the closed position and the open position is guided by the guide portion.

The weatherstrip including the attachment portion, the lip portion and the outer face cover portion is provided at the side door main body. The attachment portion extends along the aperture edge portion of the window aperture and is attached to the aperture edge portion. The lip portion protrudes from the attachment portion and is pressed against the glass end portion of the door glass when the door glass is disposed at the closed position. A gap between the glass end portion of the door glass disposed at the closed position and the aperture edge portion of the window aperture is closed off by the lip portion.

The outer face cover portion is provided to extend across the attachment portion and the guide portion. The outer face at the vehicle width direction outer side of the guide portion is covered by the outer face cover portion. As a result, when, for example, the slider is lowered along the guide portion and the door glass is moved from the closed position toward the open position, exposure of the outer face of the guide portion through the window aperture is suppressed. Thus, the appearance of the side door for a vehicle when the window aperture is open may be made excellent.

In the present aspect, the attachment portion and the lip portion are integrated with the outer face cover portion. Therefore, a number of components may be reduced in the present aspect compared to a structure in which an attachment portion and lip portion are a separate body from an outer face cover portion. Thus, in the present aspect, the appearance of the side door for a vehicle when the window aperture is open may be made excellent even though the number of components is reduced.

In a side door for a vehicle according to a second aspect, in the side door for a vehicle according to the first aspect, wherein: a pawl portion projecting toward the vehicle width direction inner side is formed at the aperture edge portion, and an attachment groove portion with which the pawl portion engages is formed at a vehicle width direction outer side of the attachment portion.

According to the side door for a vehicle according to the second aspect, the pawl portion that projects to the vehicle width direction inner side is formed at the aperture edge portion of the window aperture. Correspondingly, the attachment groove portion is formed at the vehicle width direction outer side of the attachment portion. The pawl portion is engaged with the attachment groove portion. Thus, in the present aspect, disengagement of the attachment portion from the aperture edge portion is inhibited compared to a structure in which there is no pawl portion at an aperture edge portion.

In a side door for a vehicle according to a third aspect, in the side door for a vehicle according to the second aspect, wherein the outer face cover portion is attached to the guide portion and has higher hardness than the attachment portion.

According to the side door for a vehicle according to the third aspect, the outer face cover portion is attached to the guide portion and has higher hardness than the attachment portion. The attachment portion is supported at the guide portion via the outer face cover portion.

Now, if, for example, the outer face cover portion is deformed (deformed by flexing) about the side thereof at which the guide portion is disposed toward the side thereof at which the glass end portion of the door glass is disposed, it is easy for the attachment portion to disengage from the pawl portion of the aperture edge portion.

However, in the present aspect the outer face cover portion has higher hardness than the attachment portion, as mentioned above. Therefore, in the present aspect, deformation of the outer face cover portion toward the side at which the glass end portion is disposed about the side at which the guide portion is disposed is suppressed compared to a structure in which the outer face cover portion and the attachment portion have the same hardness. As a result, disengagement of the attachment portion from the pawl portion of the aperture edge portion is inhibited.

In a side door for a vehicle according to a fourth aspect, in the side door for a vehicle according to any one of the first to third aspects, wherein the weatherstrip includes a retaining portion that wraps around from the outer face cover portion to a vehicle width direction inner side of the guide portion, and that is joined to the guide portion in a state in which the guide portion is retained between the retaining portion and the outer face cover portion.

According to the side door for a vehicle according to the fourth aspect, the weatherstrip includes the retaining portion. The retaining portion wraps around from the outer face cover portion to the vehicle width direction inner side relative to the guide portion. The retaining portion is joined to the guide portion in the state in which the guide portion is retained between the retaining portion and the outer face cover portion. Thus, compared to a structure in which a weatherstrip does not include the retaining portion, disengagement of the outer face cover portion from the guide portion is inhibited in the present aspect.

In a side door for a vehicle according to a fifth aspect, in the side door for a vehicle according to the fourth aspect, wherein: an outer side urging lip portion is provided at the side door main body, the outer side urging lip portion pressing and urging the inner face of the door glass toward the vehicle width direction outer side, the slider includes an inner side wall portion that is disposed at the vehicle width direction inner side relative to the guide portion and that structures a side wall of the slide groove portion, and an inner side urging lip portion is provided at the retaining portion, the inner side urging lip portion pressing and urging the inner side wall portion toward the vehicle width direction inner side.

According to the side door for a vehicle according to the fifth aspect, the outer side urging lip portion is provided at the side door main body. The outer side urging lip portion presses and urges the inner face of the door glass toward the vehicle width direction outer side. The slide groove portion includes the inner side wall portion that is disposed at the vehicle width direction inner side relative to the guide portion and structures a side wall of the slide groove portion.

Correspondingly, the inner side urging lip portion is provided at the retaining portion of the weatherstrip. The inner side urging lip portion presses and urges the inner side wall portion of the slide groove portion toward the vehicle width direction inner side. Thus, the inner side urging lip portion presses and urges the door glass the opposite way to the outer side urging lip portion in the vehicle width direction. Therefore, movements of the door glass in the vehicle width direction are restrained by urging forces of the outer side urging lip portion and the inner side urging lip portion. Thus, displacements, vibrations and the like of the door glass in the vehicle width direction are suppressed.

As described above, in the exemplary embodiments, both the number of components may be reduced and the appearance of a side door for a vehicle when a window aperture is open may be made excellent.

### BRIEF DESCRIPTION OF THE DRAWINGS

Exemplary embodiments will be described in detail based on the following figures, wherein:

FIG. 1 is a side view, viewed from a vehicle width direction inner side, of a vehicle side door in accordance with an exemplary embodiment;

FIG. 2 is a magnified sectional diagram cut along line 2-2 in FIG. 1;

FIG. 3 is a side view, viewed from the vehicle width direction outer side, of a rear portion of an upper portion of the vehicle side door shown in FIG. 1;

FIG. 4 is a partial magnified view of FIG. 2; and

FIG. 5 is a magnified view of a weatherstrip shown in FIG. 2.

### DETAILED DESCRIPTION

Herebelow, a vehicle side door according to an exemplary embodiment is described with reference to the attached drawings. Herein, the arrow FR that is shown where appropriate in the drawings indicates a vehicle front-rear direction front side (vehicle front side), the arrow UP indicates a vehicle vertical direction upper side (vehicle upper side), and the arrow OUT indicates a vehicle width direction outer side (vehicle cabin outer side). In the descriptions below, unless specifically stated otherwise, the terms front, rear, upper and lower indicate front-rear in the vehicle front-rear direction and upper and lower in the vehicle vertical direction.

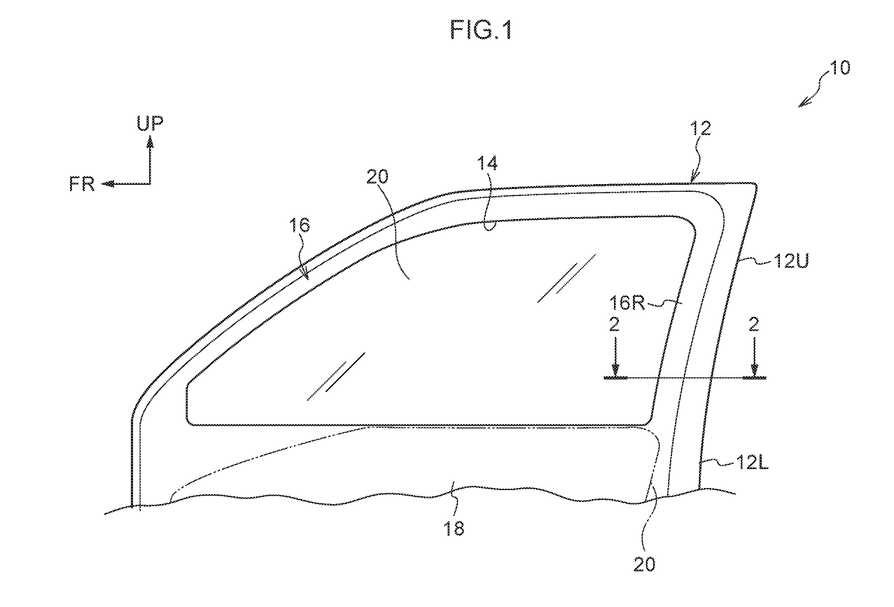

FIG. 1 shows a situation in which a vehicle side door 10 according to the present exemplary embodiment is viewed from the vehicle width direction inner side (vehicle cabin inner side) thereof. The vehicle side door 10 serves as a vehicle front side door that opens and closes a door aperture (a vehicle boarding opening) that is formed in a side portion of a vehicle front portion of the vehicle, which is not shown in the drawings.

The vehicle side door 10 is provided with a side door main body 12 and a door glass (door window glass) 20. The side door main body 12 is arranged along the vehicle front-rear direction and the vehicle vertical direction. The side door main body 12 has a window aperture 14 at an upper portion 12U. A window frame portion 16 that surrounds the window aperture 14 is provided at the upper portion 12U of the side door main body 12. At a lower portion 12L of the side door main body 12, a pair of a door inner panel and a door outer panel, which are not shown in the drawings, are provided to oppose one another in the vehicle width direction. A door trim 18 that forms a design surface at the vehicle cabin interior side is provided at the vehicle width direction inner side of the door inner panel.

The door glass 20 is provided in a plate shape at the side door main body 12 to be raisable and lowerable in the vehicle vertical direction. The window aperture 14 is opened and closed by the door glass 20 being lowered and raised relative to the side door main body 12. To be specific, the door glass 20 is raised and lowered between a closed position, at which the door glass 20 closes off the window aperture 14, and an open position as shown by the two-dot chain lines in the drawing, at which the door glass 20 is disposed at the vehicle lower side relative to the closed position and opens up the window aperture 14.

At the closed position, the door glass 20 is disposed in the window aperture 14 so as to close the window aperture 14. In contrast, at the open position, the door glass 20 is accommodated between the aforementioned door inner panel and door outer panel, which are not shown in the drawings, and at least an upper portion of the window aperture 14 is open.

Now, a raising-and-lowering structure of the door glass 20 according to the present exemplary embodiment is described in an example in which the vehicle front-rear direction rear side of the door glass 20 serves as a vehicle front-rear direction one side.

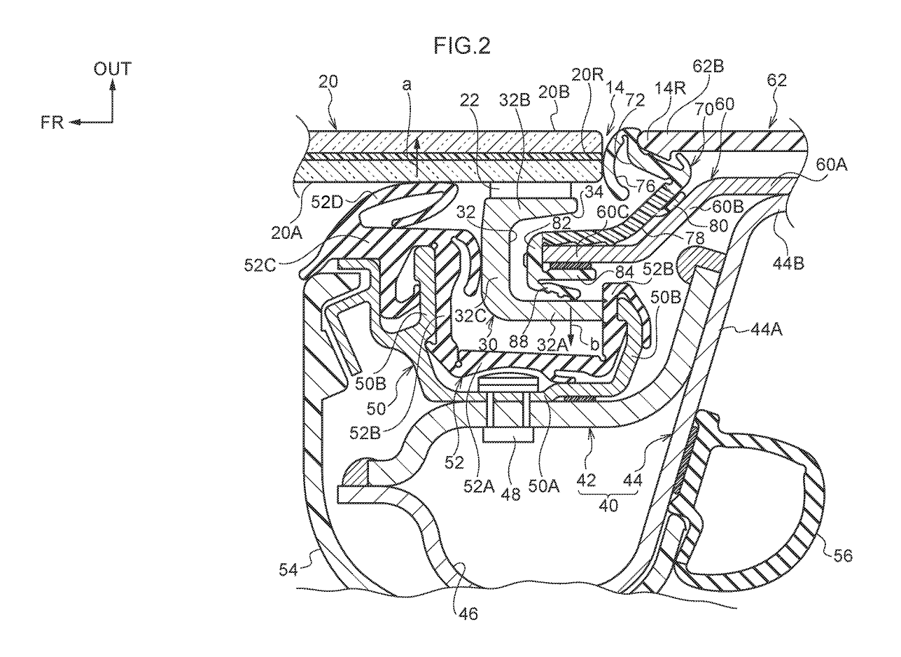

FIG. 2 shows a state in which the window aperture 14 is closed; that is, the door glass 20 is disposed at the closed position. In the following descriptions, unless specified otherwise, references to the door glass 20 refer to the state when the door glass 20 is disposed at the closed position.

As shown in FIG. 2, a slider 30 is provided at an inner face 20A at the vehicle width direction inner side of a glass end portion 20R at the vehicle front-rear direction rear side of the door glass 20. The slider 30 extends in the vehicle vertical direction along the glass end portion 20R of the door glass 20. The slider 30 includes a slide groove portion 32. A cross-sectional shape of the slide groove portion 32 as viewed from the vehicle vertical direction upper side is formed in a “U” shape of which the vehicle front-rear direction rear side is open. The slider 30 includes an inner side wall portion 32A and an outer side wall portion 32B that structure side walls of the slide groove portion 32 and a bottom wall portion 32C that structures a bottom wall of the slide groove portion 32.

The inner side wall portion 32A and outer side wall portion 32B are arranged along the vehicle front-rear direction and are disposed to oppose one another in the vehicle width direction. The outer side wall portion 32B is disposed along the inner face 20A of the glass end portion 20R and is fixed (joined) to the inner face 20A by a double-sided tape 22. A method of fixing the slider 30 to the inner face 20A of the door glass 20 is not limited to the double-sided tape 22 and may be, for example, adhesive, screws or the like.

The bottom wall portion 32C is arranged along the vehicle width direction and connects end portions at the vehicle front-rear direction front sides of the inner side wall portion 32A and outer side wall portion 32B to one another in the vehicle width direction. An insertion aperture 34 is formed between end portions at the vehicle front-rear direction rear sides of the inner side wall portion 32A and outer side wall portion 32B. A guide piece portion 60C of a raising-and-lowering guide rail 60, which is described below, is inserted into the insertion aperture 34.

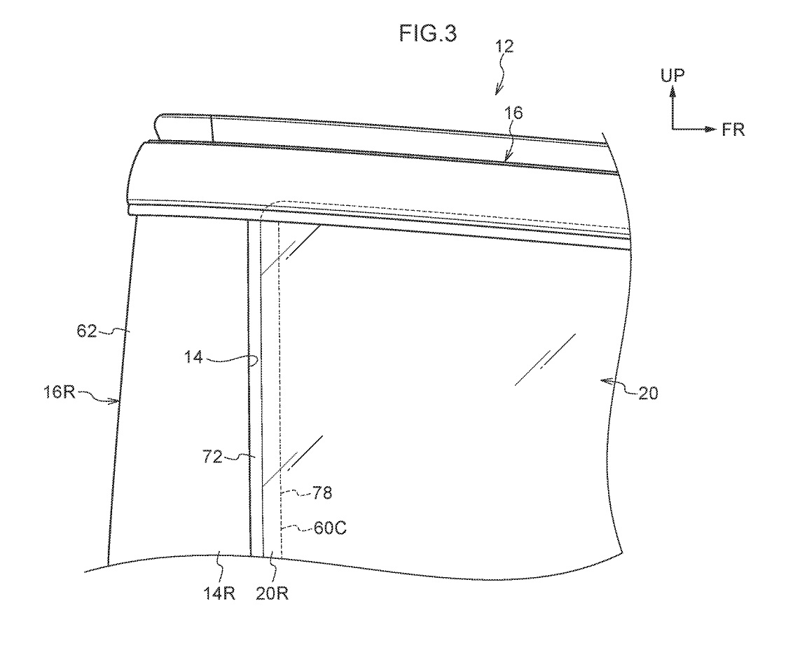

A door frame 40 is disposed at the vehicle width direction inner side of the slider 30. The door frame 40 is a framework member fabricated of metal that structures a framework of a frame portion 16R (see FIG. 3) at the vehicle front-rear direction rear side of the window frame portion 16. The door frame 40 extends in the vehicle vertical direction along the frame portion 16R. The door frame 40 includes a frame outer panel 42 and a frame inner panel 44, which is disposed at the vehicle width direction inner side of the frame outer panel 42.

The frame outer panel 42 and the frame inner panel 44 are joined to one another by welding or the like. A closed cross section portion 46, a cross-sectional shape of which as viewed from the vehicle vertical direction upper side forms a closed cross section, is formed by the frame outer panel 42 and the frame inner panel 44. The closed cross section portion 46 is disposed at the vehicle width direction inner side of the slider 30.

A glass run bracket 50 is fixed by rivets 48 to an outer face at the vehicle width direction outer side of the frame outer panel 42. The glass run bracket 50 extends in the vehicle vertical direction along the door frame 40. The slider 30 is raised and lowered along the glass run bracket 50 in the vehicle vertical direction.

To be specific, a cross-sectional shape of the glass run bracket 50 as viewed from the vehicle vertical direction upper side is formed in a “C” shape of which the vehicle width direction outer side (the side thereof at which the slider 30 is disposed) is open. The glass run bracket 50 includes a bottom wall portion 50A, which is joined to the frame outer panel 42, and a pair of side wall portions 50B, which oppose one another in the vehicle front-rear direction. The inner side wall portion 32A of the slider 30 is inserted into (disposed in) the interior of the glass run bracket 50. A glass run 52 is attached to the glass run bracket 50. The glass run 52 closes off a gap between the glass run bracket 50 and the slider 30 and a gap between the glass run bracket 50 and the door glass 20.

The glass run 52 is formed of a resilient body of rubber or the like. The glass run 52 includes a base floor portion 52A and a pair of side wall portions 52B that are disposed along the bottom wall portion 50A and pair of side wall portions 50B, respectively, of the glass run bracket 50. The glass run 52 further includes a protruding wall portion 52C and an outer side urging lip portion 52D. The protruding wall portion 52C protrudes to the vehicle front-rear direction front side from an end portion at the vehicle width direction outer side of the side wall portion 52B that is at the front side. The outer side urging lip portion 52D protrudes to the vehicle width direction outer side from the protruding wall portion 52C. The glass run bracket 50 is covered from the vehicle width direction outer side thereof by the glass run 52. Thus, the appearance of the vehicle side door 10 when the window aperture 14 is open is enhanced.

The outer side urging lip portion 52D is resiliently deformed between the protruding wall portion 52C and the inner face 20A of the door glass 20, and is pressed against the inner face 20A of the door glass 20. The outer side urging lip portion 52D presses and urges the inner face 20A of the door glass 20 toward the vehicle width direction outer side, as indicated by arrow a. Together with an inner side urging lip portion 88, which is described below, the outer side urging lip portion 52D restrains movements of the slider 30 and the door glass 20 in the vehicle width direction.

The frame inner panel 44 of the door frame 40 includes a protruding wall portion 44A that protrudes to the vehicle width direction outer side from a rear end portion of the closed cross section portion 46 and is disposed at the vehicle front-rear direction rear side of the slider 30. The frame inner panel 44 further includes a flange portion 44B that protrudes to the vehicle front-rear direction rear side from an end portion at the vehicle width direction outer side of the protruding wall portion 44A. The raising-and-lowering guide rail 60 is fixed to an outer face at the vehicle width direction outer side of the flange portion 44B.

A garnish 54 and a weatherstrip 56 are attached to the vehicle width direction inner side of the frame inner panel 44. The garnish 54 forms a design surface at the vehicle cabin interior side. The weatherstrip 56 is pressed against a center pillar, which is not shown in the drawings.

The raising-and-lowering guide rail 60 is formed of a metal plate or the like. The raising-and-lowering guide rail 60 includes a flange portion 60A, an angled wall portion 60B, and the guide piece portion 60C, which serves as an example of a guide portion. The flange portion 60A is formed at the outer face of the flange portion 44B of the frame inner panel 44. The flange portion 60A is disposed at the vehicle width direction outer side relative to the insertion aperture 34 of the slide groove portion 32.

The angled wall portion 60B protrudes from an end portion at the vehicle front-rear direction front side of the flange portion 60A to the vehicle front-rear direction front side and the vehicle width direction inner side, toward the insertion aperture 34 of the slider 30. The guide piece portion 60C protrudes to the vehicle front-rear direction front side from an end portion at the vehicle front-rear direction front side of the angled wall portion 60B. The guide piece portion 60C is inserted into the insertion aperture 34 of the slide groove portion 32.

As shown in FIG. 3, as viewed from the vehicle width direction outer side, the guide piece portion 60C extends across an aperture edge portion 14R at the vehicle front-rear direction rear side of the window aperture 14 and the glass end portion 20R of the door glass 20. In other words, viewed from the vehicle width direction outer side, the guide piece portion 60C protrudes into the window aperture 14 from the aperture edge portion 14R of the window aperture 14.

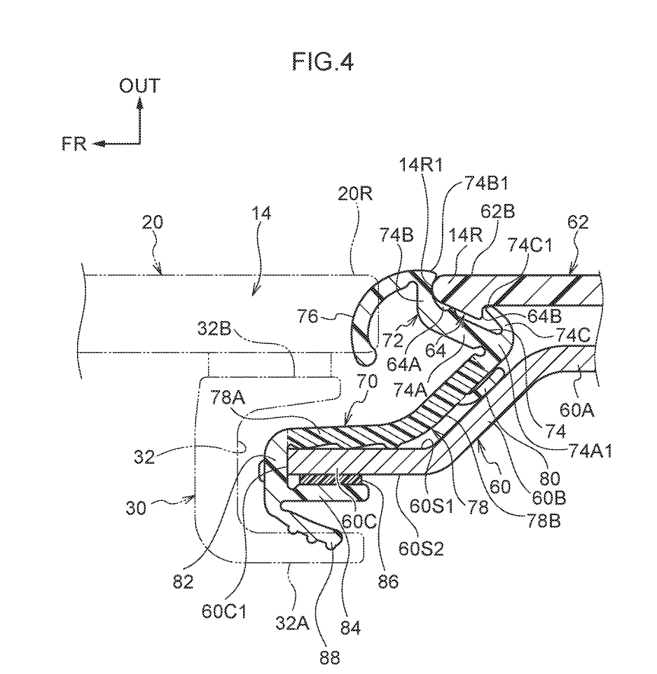

As shown in FIG. 4, an exterior panel member 62 is fixed by double-sided tape or the like, which is not shown in the drawings, to an outer face at the vehicle width direction outer side of the flange portion 60A of the raising-and-lowering guide rail 60. The exterior panel member 62 is, for example, a garnish (a decorative member) formed in a panel shape of resin or the like. The exterior panel member 62 forms an outer face (a design surface) at the vehicle width direction outer side of the side door main body 12. An end portion of the exterior panel member 62 at the side thereof at which the window aperture 14 is disposed (the vehicle front-rear direction front side) forms the aperture edge portion 14R at the vehicle front-rear direction rear side of the window aperture 14.

A pawl portion 64 is formed at the aperture edge portion 14R. A weatherstrip 70, which is described below, is attached at the pawl portion 64. The pawl portion 64 extends in the vehicle vertical direction along the aperture edge portion 14R and projects to the vehicle width direction inner side from the aperture edge portion 14R. The pawl portion 64 is formed in a triangular shape in cross section as viewed from the vehicle vertical direction upper side. The pawl portion 64 includes an inner side face 64A at the vehicle width direction inner side thereof and an engagement-receiving face 64B, which faces to the opposite side of the pawl portion 64 from the side thereof at which the window aperture 14 is disposed.

The weatherstrip 70 is provided to extend across the aperture edge portion 14R of the window aperture 14 and the guide piece portion 60C of the raising-and-lowering guide rail 60. The weatherstrip 70 includes an attachment portion 72, a lip portion 76, an outer face cover portion 78, a distal end cover portion 82 and an inner face cover portion 84.

The attachment portion 72 extends in the vehicle vertical direction along the aperture edge portion 14R and is attached to the aperture edge portion 14R. A cross-sectional shape of the attachment portion 72 as seen from the vehicle vertical direction upper side is formed in a “C” shape of which the vehicle width direction outer side is open. An attachment groove portion 74 is formed in the vehicle width direction outer side of the attachment portion 72. The attachment groove portion 74 extends in the vehicle vertical direction along the attachment portion 72. The attachment groove portion 74 includes a bottom wall portion 74A and a pair of retaining wall portions 74B and 74C.

The bottom wall portion 74A is arranged along the inner side face 64A of the pawl portion 64. Of the pair of retaining wall portions 74B and 74C, the retaining wall portion 74B, which is at the side at which the window aperture 14 is disposed, protrudes to the vehicle width direction outer side from an end portion of the bottom wall portion 74A at the side thereof at which the window aperture 14 is disposed. The retaining wall portion 74B is pressed against a distal end 14R1 of the aperture edge portion 14R. The retaining wall portion 74B is formed such that a distal end portion 74B1 at the vehicle width direction outer side of the retaining wall portion 74B does not project further to the vehicle width direction outer side than an outer face 62B of the aperture edge portion 14R. Thus, design appearance of the vehicle side door 10 is enhanced.

Of the pair of retaining wall portions 74B and 74C, the retaining wall portion 74C that is at the opposite side from the side at which the window aperture 14 is disposed protrudes to the vehicle width direction outer side from an end portion 74M of the bottom wall portion 74A at the opposite side thereof from the side at which the window aperture 14 is disposed. The retaining wall portion 74C is angled toward the side at which the window aperture 14 is disposed relative to the bottom wall portion 74A. A distal end portion 74C1 at the vehicle width direction outer side of the retaining wall portion 74C engages with (hooks onto) the engagement-receiving face 64B of the pawl portion 64. Thus, the attachment portion 72 is attached to the aperture edge portion 14R by retaining the pawl portion 64 from both sides thereof with the pair of retaining wall portions 74B and 74C.

The lip portion 76 extends in the vehicle vertical direction along the attachment portion 72. As shown in FIG. 2, the lip portion 76 protrudes toward the side at which the window aperture 14 is disposed from the side of the retaining wall portion 74B at which the distal end portion 74B1 is disposed. The lip portion 76 is pressed against an end face of the glass end portion 20R. A gap between the glass end portion 20R and the aperture edge portion 14R is closed off by the lip portion 76.

In the present exemplary embodiment, the outer face 62B at the vehicle width direction outer side of the aperture edge portion MR and an outer face 20B at the vehicle width direction outer side of the glass end portion 20R are coplanar. Thus, design appearance of the vehicle side door 10 is enhanced.

The meaning of the recitation “the outer face 62B of the aperture edge portion 14R and the outer face 20B of the glass end portion 20R are coplanar” as used herein includes not just structures in which there is no step between the outer face 62B and the outer face 20B but also structures in which there is a slight step between the outer face 62B and the outer face 20B due to, for example, errors in fabrication of the door glass 20 and the exterior panel member 62 and suchlike.

As shown in FIG. 4, the outer face cover portion 78 extends in the vehicle vertical direction along the attachment portion 72 and the guide piece portion 60C. The outer face cover portion 78 extends between the end portion 74A1 of the attachment portion 72 and a distal end 60C1 of the guide piece portion 60C. An outer face 60S1 at the vehicle width direction outer sides of the guide piece portion 60C and angled wall portion 60B is covered by the outer face cover portion 78.

The outer face cover portion 78 includes a holding wall portion 78A that is arranged along the guide piece portion 60C and a connecting wall portion 78B that connects the holding wall portion 78A with the attachment portion 72. The holding wall portion 78A is disposed between the guide piece portion 60C and the outer side wall portion 32B of the slide groove portion 32 in a state in which the holding wall portion 78A is separated from the outer side wall portion 32B. The connecting wall portion 78B is angled relative to the holding wall portion 78A and is arranged along the angled wall portion 60B.

An auxiliary lip portion 80 is provided at the connecting wall portion 78B, protruding toward the side thereof at which the angled wall portion 60B is disposed. In the state in which the distal end portion 74C1 of the retaining wall portion 74C of the attachment groove portion 74 is engaged with the engagement-receiving face 64B of the pawl portion 64, the auxiliary lip portion 80 is resiliently deformed between the connecting wall portion 78B and the angled wall portion 60B and the auxiliary lip portion 80 is pressed against the outer face of the angled wall portion 60B. The distal end portion 74C1 of the retaining wall portion 74C is pressed against the engagement-receiving face 64B of the pawl portion 64 by the resilient force of this auxiliary lip portion 80. That is, the auxiliary lip portion 80 receives a reaction force from the angled wall portion 60B and presses and urges the distal end portion 74C1 of the retaining wall portion 74C toward the side thereof at which the engagement-receiving face 64B of the pawl portion 64 is disposed.

The inner face cover portion 84, which serves as an example of a retaining portion, is connected to the holding wall portion 78A of the outer face cover portion 78 via the distal end cover portion 82. The inner face cover portion 84 wraps around from the holding wall portion 78A to the vehicle width direction inner side of the guide piece portion 60C. To be specific, the distal end cover portion 82 protrudes from an end portion at the vehicle front-rear direction front side of the outer face cover portion 78 along a distal end face of the guide piece portion 60C toward the vehicle width direction inner side. The inner face cover portion 84 is provided at an end portion at the vehicle width direction inner side of the distal end cover portion 82.

The inner face cover portion 84 protrudes from the end portion at the vehicle width direction inner side of the distal end cover portion 82 along an inner face 60S2 at the vehicle width direction inner side of the guide piece portion 60C toward the vehicle front-rear direction rear side. In a state in which the guide piece portion 60C is retained between the inner face cover portion 84 and the holding wall portion 78A of the outer face cover portion 78, the inner face cover portion 84 is joined to the inner face 60S2 of the guide piece portion 60C by a double-sided tape 86. Thus, the weatherstrip 70 is fixed to the guide piece portion 60C.

A method of joining the inner face cover portion 84 to the guide piece portion 60C is not limited to the double-sided tape 86 and may be, for example, adhesive, a weld or the like.

The inner side urging lip portion 88 is provided at the inner face cover portion 84, protruding toward the inner side wall portion 32A of the slider 30. As shown in FIG. 2, the inner side urging lip portion 88 is resiliently deformed between the outer face cover portion 78 and the inner side wall portion 32A of the slider 30, and is pressed against an outer face at the vehicle width direction outer side of the inner side wall portion 32A. A gap between the inner face cover portion 84 and the inner side wall portion 32A is closed off by this inner side urging lip portion 88.

The inner side urging lip portion 88 presses and urges the inner side wall portion 32A of the slider 30 toward the vehicle width direction inner side, as indicated by arrow b. That is, the inner side urging lip portion 88 presses and urges the slider 30 and the door glass 20 the opposite way in the vehicle width direction to the outer side urging lip portion 52D described above. Thus, the door glass 20 is positioned relative to the side door main body 12 in the vehicle width direction by the inner side urging lip portion 88 and the outer side urging lip portion 52D.

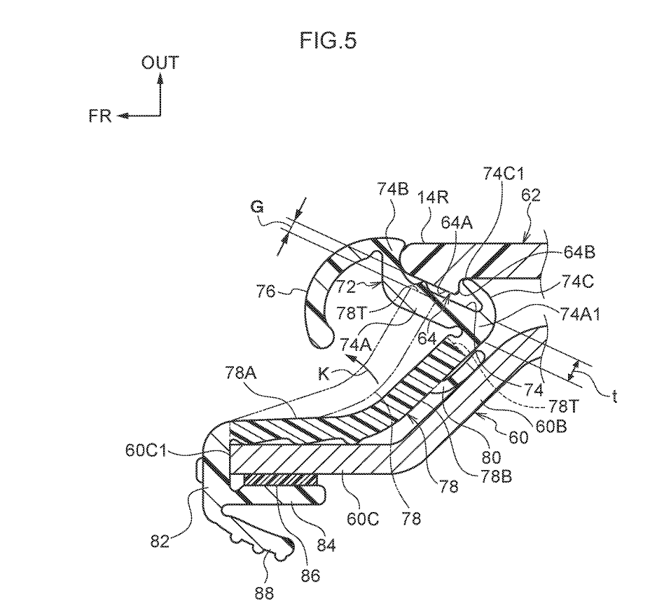

The outer face cover portion 78 is formed of a hard material with a higher hardness than other portions of the weatherstrip 70, which is to say the attachment portion 72, the lip portion 76, the distal end cover portion 82 and the inner face cover portion 84 of the weatherstrip 70. To be specific, the other portions of the weatherstrip 70 are formed of, for example, resilient materials such as resin, rubber or the like, while the outer face cover portion 78 is formed of a hard material such as resin, rubber, metal or the like with a higher hardness than the other portions of the weatherstrip 70. Consequently, the outer face cover portion 78 is resistant to deformation (flexing deformation) toward the side at which the glass end portion 20R is disposed about the side of the outer face cover portion 78 at which the distal end 60C1 of the guide piece portion 60C is disposed, as illustrated by arrow K in FIG. 5.

If a boundary portion 78T between the outer face cover portion 78 and the attachment portion 72 approaches close to the inner side face 64A of the pawl portion 64 in accordance with deformation of the outer face cover portion 78 toward the side at which the glass end portion 20R is disposed, as shown by the two-dot chain lines, then if a gap formed between the boundary portion 78T and the inner side face 64A of the pawl portion 64 is represented by G, the gap G becomes narrower than a thickness t of the end portion 74A1 of the attachment portion 72 (G<t). Therefore, it is hard for the end portion 74A1 of the attachment portion 72 to pass through the gap G. Consequently, the outer face cover portion 78 is resistant to deformation (flexing deformation) toward the side thereof at which the glass end portion 20R is disposed about the side at which the distal end 60C1 of the guide piece portion 60C is disposed.

Hardnesses of the outer face cover portion 78 and the other portions of the weatherstrip 70 are compared by comparing IIHS hardnesses thereof. For example, as the material used for the weatherstrip 70, thermoplastic vulcanized rubber (TPV), ethylene propylene diene rubber (EPDM) and polypropylene (PP) can be mentioned. The outer face cover portion 78 may be formed of a high stiffness material such as a resin, rubber, metal or the like with a higher stiffness (flexing stiffness) than the other portions of the weatherstrip 70 (the attachment portion 72, the lip portion 76, the distal end cover portion 82 and the inner face cover portion 84).

Now, operation of the present exemplary embodiment is described.

As shown in FIG. 2, according to the present exemplary embodiment, the glass run bracket 50 and the raising-and-lowering guide rail 60 are provided at the side door main body 12 of the vehicle side door 10. Correspondingly, the slider 30 is fixed to the inner face 20A of the glass end portion 20R of the door glass 20. Raising and lowering of the door glass 20 between the closed position and the open position is guided by the glass run bracket 50 and the raising-and-lowering guide rail 60, by the slider 30 being raised and lowered along the glass run bracket 50 and the raising-and-lowering guide rail 60.

As a comparative example, in, for example, a structure in which raising and lowering of the door glass 20 is guided by a glass channel that retains the glass end portion 20R of the door glass 20 from both sides in the vehicle width direction, a garnish or the like that forms a design surface is disposed at the vehicle width direction outer side of the glass channel. Consequently, it is difficult to make the design surface coplanar with the outer face 20B of the glass end portion 20R.

By contrast, in the present exemplary embodiment the slider 30 is fixed to the inner face 20A of the door glass 20 as described above. The slider 30 is raised and lowered along the glass run bracket 50 and the raising-and-lowering guide rail 60 that are disposed at the vehicle width direction inner side of the glass end portion 20R. Consequently, the outer face 20B of the glass end portion 20R may be made coplanar with the outer face 62B of the aperture edge portion 14R that forms a design surface. Thus, design appearance of the vehicle side door 10 is improved.

In the present exemplary embodiment, the guide piece portion 60C is disposed at the vehicle width direction inner side relative to the glass end portion 20R. In such a structure, when the slider 30 and the door glass 20 are lowered along the guide piece portion 60C in order to open the window aperture 14, the outer face 60S1 of the guide piece portion 60C may be exposed through the window aperture 14, which may adversely affect the appearance of the vehicle side door 10.

However, in the present exemplary embodiment the outer face 60S1 of the guide piece portion 60C is covered by the outer face cover portion 78 of the weatherstrip 70. Therefore, when the slider 30 and the door glass 20 are lowered along the guide piece portion 60C, exposure of the outer face 60S1 of the guide piece portion 60C through the window aperture 14 is suppressed. Thus, the appearance of the vehicle side door 10 when the window aperture 14 is open may be made excellent.

The outer face cover portion 78 is made integral with the attachment portion 72 and lip portion 76. Therefore, in the present exemplary embodiment, a number of components is reduced compared to a structure in which the outer face cover portion 78 is a separate body from the attachment portion 72 and lip portion 76.

Thus, in the present exemplary embodiment, both the number of components may be reduced and the appearance of the vehicle side door 10 when the window aperture 14 is open may be made excellent.

The outer face cover portion 78 is provided to extend across the distal end 60C1 of the guide piece portion 60C and the attachment portion 72. The outer face cover portion 78 covers over the whole length of the outer face 60S1 of the guide piece portion 60C in the vehicle front-rear direction. Furthermore, the outer face cover portion 78 covers the outer face 60S1 of the angled wall portion 60B as well as the guide piece portion 60C. Thus, the appearance of the vehicle side door 10 when the window aperture 14 is open may be made even more excellent.

The glass run bracket 50 is covered from the vehicle width direction outer side thereof by the glass run 52. Therefore, when the window aperture 14 is open, exposure of the glass run bracket 50 through the window aperture 14 is suppressed. Thus, the appearance of the vehicle side door 10 when the window aperture 14 is open may be made even more excellent.

The attachment groove portion 74 that retains the aperture edge portion 14R is formed at the attachment portion 72 of the weatherstrip 70. The retaining wall portion 74B, at the side of the attachment groove portion 74 at which the window aperture 14 is provided, is disposed such that the distal end portion 74B1 does not project further to the vehicle width direction outer side than the outer face 62B of the aperture edge portion 14R. Thus, the appearance of the vicinity of the aperture edge portion 14R may be made more excellent than in a structure in which the retaining wall portion 74B of the attachment groove portion 74 projects further to the vehicle width direction outer side than the outer face 62B of the aperture edge portion 14R.

In the structure in which the distal end portion 74B1 of the retaining wall portion 74B of the attachment groove portion 74 does not project further to the vehicle width direction outer side than the outer face 62B of the aperture edge portion 14R, the retaining wall portion 74B might not hook onto the outer face 62B of the aperture edge portion 14R and it is easy for the attachment portion 72 to disengage from the aperture edge portion 14R.

However, in the present exemplary embodiment the pawl portion 64 that projects to the vehicle width direction inner side is formed at the aperture edge portion 14R of the window aperture 14. The pawl portion 64 engages with (fits into) the attachment groove portion 74. In this state, the distal end portion 74C1 of the retaining wall portion 74C of the attachment groove portion 74 is engaged with the engagement-receiving face 64B of the pawl portion 64. Consequently, the attachment portion 72 is unlikely to disengage from the aperture edge portion 14R. Thus, in the present exemplary embodiment, disengagement of the attachment portion 72 from the aperture edge portion 14R is inhibited compared to a structure in which the pawl portion 64 is not provided at the aperture edge portion 14R.

In the present exemplary embodiment, the attachment portion 72 is attached to the aperture edge portion 14R by the aperture edge portion 14R (the pawl portion 64) being retained from both sides by the pair of retaining wall portions 74B and 74C of the attachment groove portion 74. Therefore, in the present exemplary embodiment, the work of an operation to attach the attachment portion 72 to the aperture edge portion 14R is reduced compared to, for example, a structure in which the attachment portion 72 is joined to the aperture edge portion 14R by double-sided tape or the like.

If the outer face cover portion 78 of the weatherstrip 70 deforms (deforms by flexing) toward the side thereof at which the glass end portion 20R is disposed about the side thereof at which the distal end 60C1 of the guide piece portion 60C is disposed, for example, as shown by arrow K in FIG. 5, it will be easy for the aperture edge portion 14R to disengage from the attachment groove portion 74.

However, in the present exemplary embodiment the outer face cover portion 78 is formed of a hard material with higher hardness than the attachment portion 72. Therefore, in the present exemplary embodiment, deformation of the outer face cover portion 78 toward the side at which the glass end portion 20R is disposed about the side at which the distal end 60C1 of the guide piece portion 60C is disposed is suppressed compared to a structure in which the outer face cover portion 78 and the attachment portion 72 have the same hardness. Thus, disengagement of the attachment portion 72 from the aperture edge portion 14R is even further inhibited.

The auxiliary lip portion 80 that protrudes toward the side at which the angled wall portion 60B is disposed is provided at the connecting wall portion 78B of the outer face cover portion 78. In the state in which the distal end portion 74C1 of the retaining wall portion 74C of the attachment groove portion 74 is engaged with the engagement-receiving face 64B of the pawl portion 64, the auxiliary lip portion 80 is resiliently deformed between the connecting wall portion 78B and the angled wall portion 60B and is pressed against the outer face 60S1 of the angled wall portion 60B. Thus, the distal end portion 74C1 of the retaining wall portion 74C is pressed against the engagement-receiving face 64B of the pawl portion 64 by a resilient force of the auxiliary lip portion 80. Therefore, disengagement of the attachment portion 72 from the aperture edge portion 14R is even further inhibited.

The inner face cover portion 84 of the weatherstrip 70 wraps around to the side of the guide piece portion 60C at which the inner face 60S2 is provided. In the state in which the inner face cover portion 84 retains the guide piece portion 60C between the inner face cover portion 84 and the outer face cover portion 78, the inner face cover portion 84 is joined to the inner face 60S2 of the guide piece portion 60C. Thus, in the present exemplary embodiment, disengagement of the outer face cover portion 78 from the guide piece portion 60C is inhibited compared to a structure in which the inner face cover portion 84 is not provided at the weatherstrip 70.

The inner side urging lip portion 88 is provided at the inner face cover portion 84. As shown by arrow b in FIG. 2, the inner side urging lip portion 88 presses and urges the inner side wall portion 32A of the slider 30 toward the vehicle width direction inner side. Correspondingly, the outer side urging lip portion 52D is provided at the glass run 52. As shown by arrow a, the outer side urging lip portion 52D presses and urges the inner face 20A of the door glass 20 toward the vehicle width direction outer side. In other words, the inner side urging lip portion 88 presses and urges the slider 30 and the door glass 20 the opposite way in the vehicle width direction to the outer side urging lip portion 52D. Thus, movements of the door glass 20 in the vehicle width direction are restrained by the urging forces (pressing forces) of the inner side urging lip portion 88 and the outer side urging lip portion 52D. Therefore, for example, displacements, vibrations and the like of the door glass 20 in the vehicle width direction are suppressed.

The inner side urging lip portion 88 is integrated with the weatherstrip 70. Therefore, in the present exemplary embodiment, the work of an operation to attach the inner side urging lip portion 88 to the raising-and-lowering guide rail 60 is reduced compared to a structure in which the inner side urging lip portion 88 is provided separately from the weatherstrip 70.

Now, variant examples of the above exemplary embodiment are described.

In the exemplary embodiment described above, the outer face cover portion 78 has a higher hardness than the attachment portion 72, lip portion 76, distal end cover portion 82 and inner face cover portion 84 of the weatherstrip 70. However, the above exemplary embodiment is not limited thus. Disengagement of the attachment portion 72 from the aperture edge portion 14R of the window aperture 14 may be suppressed by the outer face cover portion 78 having a higher hardness than at least the attachment portion 72. Furthermore, the outer face cover portion 78 may be formed integrally with the attachment portion 72 of a material with the same hardness as the attachment portion 72.

In the exemplary embodiment described above, the attachment portion 72 is attached to the aperture edge portion 14R by the pawl portion 64 of the aperture edge portion 14R being engaged with the attachment groove portion 74 formed at the attachment portion 72 of the weatherstrip 70, but the above exemplary embodiment is not limited thus. For example, the attachment groove portion 74 and the pawl portion 64 may be omitted and the attachment portion 72 may be attached to the aperture edge portion 14R by double-sided tape, adhesive or the like.

In the above exemplary embodiment, the distal end cover portion 82 and the inner face cover portion 84 are provided at the weatherstrip 70. However, the distal end cover portion 82 and inner face cover portion 84 may be omitted. In this case, the outer face cover portion 78 may be attached to the guide piece portion 60C by, for example, the outer face cover portion 78 being joined to the guide piece portion 60C by double-sided tape, adhesive or the like, and the outer face cover portion 78 may be hooked onto the distal end portion of the guide piece portion 60C.

In the exemplary embodiment described above, the slider 30 is raised and lowered along the guide piece portion 60C that serves as the guide portion, but the above exemplary embodiment is not limited thus. Structures of the slider and the guide portion may be modified as appropriate.

In the exemplary embodiment described above, the outer face 62B of the aperture edge portion 14R and the outer face 20B of the glass end portion 20R are coplanar, but the outer face 62B and outer face 20B need not necessarily be coplanar.

In the exemplary embodiment described above, the vehicle side door 10 is a front side door, and the weatherstrip 70 is employed at the vehicle front-rear direction rear side serving as the one vehicle front-rear direction side of the vehicle side door 10, but the above exemplary embodiment is not limited thus. The weatherstrip 70 may be applied at, for example, a vehicle front-rear direction front side serving as the one vehicle front-rear direction side of a rear side door.

Hereabove, an exemplary embodiment of the present disclosure has been described, but the present disclosure is not limited by this exemplary embodiment. The exemplary embodiment and various variant examples may be used in suitable combinations, and it will be clear that numerous modes may be embodied within a technical scope not departing from the gist of the present disclosure.

What is claimed is:

1. A side door for a vehicle, comprising:
a side door main body including a window aperture at an upper portion of the side door main body;
a door glass provided at the side door main body, the door glass being raised and lowered between a closed position, at which the door glass closes the window aperture, and an open position, at which the door glass is disposed at a vehicle lower side relative to the closed position and opens the window aperture;
a raising-and-lowering guide rail provided at the side door main body, the raising-and-lowering guide rail including a guide portion that is disposed at a vehicle width direction inner side relative to a glass end portion at one vehicle front-rear direction side of the door glass when the door glass is disposed at the closed position, and the guide portion extending in the vehicle vertical direction along the glass end portion;
a slider including a slide groove portion that is open at the one vehicle front-rear direction side, the guide portion being inserted into the interior of the slide groove portion, the slider being fixed to an inner face at the vehicle width direction inner side of the glass end portion, and the slider being raised and lowered along the guide portion; and
a weatherstrip provided at the side door main body, the weatherstrip including:
an attachment portion that extends along an aperture edge portion at the one vehicle front-rear direction side of the window aperture and is attached to the aperture edge portion,
a lip portion that protrudes from the attachment portion and is pressed against the glass end portion of the door glass when the door glass is disposed at the closed position, and
an outer face cover portion that is provided extending across the attachment portion and the guide portion and that covers an outer face of the guide portion at a vehicle width direction outer side of the guide portion.

2. The side door for a vehicle according to claim 1, wherein:
a pawl portion projecting toward the vehicle width direction inner side is formed at the aperture edge portion, and
an attachment groove portion with which the pawl portion engages is formed at a vehicle width direction outer side of the attachment portion.

3. The side door for a vehicle according to claim 2, wherein the outer face cover portion is attached to the guide portion and has higher hardness than the attachment portion.

4. The side door for a vehicle according to claim 2, wherein the attachment groove portion includes a pair of retaining wall portions that retain the pawl portion from both sides of the pawl portion in the vehicle front-rear direction.

5. The side door for a vehicle according to claim 4, wherein, of the pair of retaining wall portions, a retaining wall portion at a side at which the window aperture is provided is disposed so as not to project further to a vehicle width direction outer side than an outer face of the aperture edge portion at a vehicle width direction outer side of the aperture edge portion.

6. The side door for a vehicle according to claim 4, wherein:
the pawl portion includes an engagement-receiving face that faces an opposite side to a side of the pawl portion at which the window aperture is provided, and,
of the pair of retaining wall portions, a retaining wall portion at an opposite side to the side at which the window aperture is provided engages with the engagement-receiving face.

7. The side door for a vehicle according to claim 6, wherein:
the outer face cover portion includes:
a holding wall portion arranged along the guide portion, and
a connecting wall portion that connects the holding wall portion and the attachment portion; and
an auxiliary lip portion is provided at the connecting wall portion, the auxiliary lip portion receiving a reaction force from the raising-and-lowering guide rail and pressing, of the pair of retaining wall portions, the retaining wall portion at the opposite side from the side at which the window aperture is provided against the engagement-receiving face.

8. The side door for a vehicle according to claim 1, wherein, as viewed from the vehicle width direction outer side, the guide portion protrudes into the window aperture from the aperture edge portion and extends across the aperture edge portion and the glass end portion.

9. The side door for a vehicle according to claim 8, wherein the outer face cover portion extends across the attachment portion and a distal end of the guide portion.

10. The side door for a vehicle according to claim 1, wherein the weatherstrip includes a retaining portion that wraps around from the outer face cover portion to a vehicle width direction inner side of the guide portion, and that is joined to the guide portion in a state in which the guide portion is retained between the retaining portion and the outer face cover portion.

11. The side door for a vehicle according to claim 10, wherein:
an outer side urging lip portion is provided at the side door main body, the outer side urging lip portion pressing and urging the inner face of the door glass toward the vehicle width direction outer side,
the slider includes an inner side wall portion that is disposed at the vehicle width direction inner side relative to the guide portion and that structures a side wall of the slide groove portion, and
an inner side urging lip portion is provided at the retaining portion, the inner side urging lip portion pressing and urging the inner side wall portion toward the vehicle width direction inner side.

12. The side door for a vehicle according to claim 1, wherein the attachment portion, the lip portion and the outer face cover portion are integrated.
